(19) United States
(12) Patent Application Publication
(10) Pub. No.: US 2011/0003092 A1
(43) Pub. Date: Jan. 6, 2011

(54) Silicone Optical Film

(75) Inventors: Thomas Lovgren, Kungalv (SE); Benny Nystrom, Kungalv (SE)

Correspondence Address: QUARLES & BRADY LLP, 411 E. WISCONSIN AVENUE, SUITE 2040, MILWAUKEE, WI, 53202-4497, US

(73) Assignee: Brady Worldwide, Inc., Milwaukee, WI (US)

(21) Appl. No.: 12/497,336

(22) Filed: Jul. 2, 2009

(51) Int. Cl. B32B 25/20; B32B 27/06; B32B 7/06

(52) U.S. Cl. 428/1.32; 428/447; 428/429; 428/337; 428/334; 428/339

(57) ABSTRACT

An optical film comprising a silicone elastomer having a support surface and an opposing liner surface; a releasable support contacting at least a portion of the support surface; and a releasable liner contacting at least a portion of the liner surface. The releasable support has a first release tension from the silicone elastomer and the releasable liner has a second release tension from the silicone elastomer, wherein the first release tension and the second release tension are different. In one embodiment, the first release tension is higher than the second release tension, with the first release tension being at least 20% higher than the second release tension. An image display device comprising the optical film is also provided. The optical film provides increase durability, reworkability and workability for improved assembly and manufacturing of image display devices.

### CROSS REFERENCES TO RELATED APPLICATIONS

Not Applicable.

### STATEMENT REGARDING FEDERALLY SPONSORED RESEARCH

Not Applicable.

### TECHNICAL FIELD

This invention relates to optical films, and particularly to silicone optical films for use in the automated assembly of image display devices.

### DESCRIPTION OF THE BACKGROUND ART

Image display devices such as liquid crystal display (LCD) devices, organic electroluminescence devices (OELDs), plasma display panel (PDP) devices and the like are well-known devices commonly used in many flat-panel electronic devices, such as portable media players, cellular phones, computer monitors, televisions, and the like. The thin structure of these devices permitted by the relatively thin image display panels provides more aesthetic appeal than larger conventional displays, such as picture-tube televisions. However, thin image display panels are typically more fragile than conventional displays. As such, contact with other objects during assembly and during use by a consumer can easily damage a thin image display panel.

To address this drawback, most conventional image display devices are assembled with protective glass panels, transparent optical film layers (“optical fillers”), or combinations of both. The optical films are often difficult to convert (i.e., cut in to shapes) for assembly.

The converted films also provide additional drawbacks for image display assemblies and manufacturing methods. For example, the structure of image display assemblies sometimes traps gas bubbles between the image display panel, the optical film layers, and the glass panels. For this reason, manufacturing is conducted, for the most part, within a vacuum chamber, requiring a substantial amount of power to maintain the vacuum. These high power requirements can dramatically increase the cost of image display assemblies.

Further still, image display devices using optical films of the prior art are manually assembled by technicians. Such tasks are highly repetitive and detail-oriented, and technician fatigue can result in poorly created assemblies in which components are not properly positioned relative to one another. Such assemblies typically require subsequent reworking. However, conventional display devices use acrylic-based, curable materials as optical fillers to protect the displays. Conventional acrylic optical fillers are difficult to work with during the conversion process (where the optical film is die-cut into the appropriate shape) and during the assembly and manufacturing processes, where the converted film is assembled with an image display device. Optical films of the prior art typically exhibit a poor durability and reworkability, resulting in high waste levels and increased costs.

Accordingly, there remains a need for an improved optical film useful as an optical filler to protect an image display device from the environment and provide improved durability, workability and reworkability for ease of conversion into die-cut shapes and for automated assembly that overcomes or alleviates the shortcomings of the prior art devices.

### SUMMARY OF THE INVENTION

The present invention provides an optical film comprising a silicone elastomer having a support surface and an opposing liner surface; a releasable support contacting at least a portion of the support surface; and a releasable liner contacting at least a portion of the liner surface. The releasable support has a first release tension from the silicone elastomer and the releasable liner has a second release tension from the silicone elastomer, wherein the first release tension and the second release tension are different. In one embodiment, the first release tension is higher than the second release tension, with the first release tension ranging from 0.25-1.90 N/in, and the second release tension is at least 20% less than the first release tension. In other embodiments the second release tension is at least 40-70% less than the first release tension.

The optical film of the present invention provides many advantages over the prior art. For instance, the improved release tensions of the releasable support and releasable liner makes the optical film advantageously suitable for automated assembly in an image display device. The optical film exhibits an increased durability against heating, humidifying, and does not easily shrink or expand under heating or humidifying conditions. The optical film exhibits an improved workability, such that it can be worked without fouling or dropout during die-cutting or during assembly in any device, including non-alkali glass (such as liquid crystal cells). The optical film also exhibits improved reworkability such that when improperly assembled with an image device, the film of the present invention can be easily peeled off from the device with no residue or rupture. This quality is not provided by films of the prior art. The optical film of the present invention also has no need for a lengthy, time-consuming and expensive curing process, further easing conversion and automated assembly with image devices.

The foregoing and other advantages of the invention will appear from the following description. In the description, reference is made to the accompanying drawings which form a part hereof, and in which there is shown by way of illustration a preferred embodiment of the invention. Such embodiment does not necessarily represent the full scope of the invention, however, and reference is made therefore to the claims herein for interpreting the scope of the invention.

### BRIEF SUMMARY OF THE DRAWINGS

FIG. 1 is a sectional view of a first embodiment of the optical film of the present invention.

FIG. 2 is a front view of the optical film of the present invention for use in an automated assembly process with an image device with the release liner (hatched) releasably attached to the silicone elastomer.

### DETAILED DESCRIPTION OF THE PREFERRED EMBODIMENTS

The present invention provides an improved optical film for use as an optical filler in image display devices, including, for instance, liquid crystal display (LCD) devices, organic electroluminescence devices (OELDs), plasma display panel (PDP) devices, and the like commonly used in many flat-panel electronic devices, such as portable media players, cellular phones, computer monitors and televisions.

The optical film of the present invention comprises at least one silicone elastomer (gel) material having advantageous adhesive and assembly properties for use as an optical filler in an image display device, a releasable support and a releasable liner.

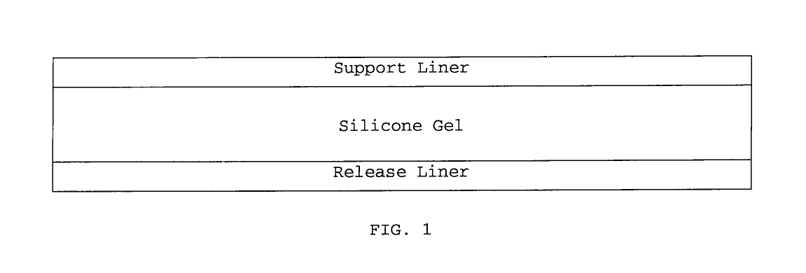

In one embodiment, the present invention provides an optical film comprising a silicone elastomer having a support surface and an opposing liner surface; a releasable support contacting at least a portion of the support surface; and a releasable liner contacting at least a portion of the liner surface (FIG. 1). The releasable support has a first release tension from the silicone elastomer and the releasable liner has a second release tension from the silicone elastomer, wherein the first release tension and the second release tension are different. In one embodiment, the first release tension is higher than the second release tension. For instance, in one embodiment the first release tension ranges from 0.25-1.90 N/in, and the second release tension is at least 20% less than the first release tension. In alternate embodiments the second release tension may be at least 20%-95% less than the first release tension, at least 30%-80% less, or at least 40%-70% less than the first release tension.

By “optical film” we mean a film comprising structured layers of different materials having advantageous adhesive, conversion and assembly properties for use as optical filler in an image display device.

By “silicone elastomer” or “silicone gel” we mean any inert, semi-inorganic polymeric silicone compound known to one of skill in the art cured to form a soft gel. The silicone gel exhibits improved release tensions on a support surface and liner surface of the gel. By “support surface” we mean the surface of the silicone gel that contacts and bonds to a support. By “liner surface” we mean the opposing surface of the silicone gel that contacts and bonds to a liner.

The silicone gel of the present invention also typically exhibits a wide range of thermal stability (−115° C. to 300° C.) and extreme water repellence, and is used in a multitude of industrial applications. Silicone polymers and elastomers have excellent electrical properties, increased flexibility, provide good UV and chemical resistance, are resistant to humidity and water, provide little to no toxicity, provide reduced thermal stress, control vibration, offer a low ionic content, a low volatile content, allow reworking and are easy to use. The silicone gel used in the present invention is commercially available from suppliers known to one of skill in the art and exhibits (1) a high transmittance of 85% or higher in the visible light range (380-780 nm) at a thickness of 0.5 mm; (2) a refractive index equivalent to that of acrylic material, ranging from about 1.35-1.45, preferably 1.40, 1.41, 1.42; and (3) excellent shock absorbing characteristics, stress relaxation properties, durability, reworkability and a high resistance to light. The very low shrinking coefficient and thermal stability of the optical film ensure an extremely stable physical and optical coupling between the support/liner and the silicone gel. The thermal stability of the optical film allows it to be used in temperatures ranging from −40 to 110° C. Of course, other forms of silicone gel having the improved release tensions with the support and liner materials of the present invention may be used in the optical film of the present invention. One of skill in the art will understand how to evaluate the characteristics of a silicone gel known to the art for use in a given application.

By “releasable support” we mean any support known to persons of ordinary skill in the art that will provide support to the silicone gel but remain removable from the silicone gel. In use, the support allows the silicone gel to maintain its structure and form during conversion into appropriate shapes for assembly. The support also maintains the structure and form of the silicone gel during storage and transport, as well as during assembly in an image display device, at which point the support is removed from the silicone gel. The support may be any material known to the art that provides the requisite support to the silicone gel, including but not limited to metal, ceramic, glass, plastic and the like and combinations thereof. In one embodiment the support is a plastic layer selected from the group consisting of a polyester resin, such as polyethylene terephthalate (PET); a polyacrylate resin, such as polymethyl methacrylate (PMMA); a polyolefin resin, such as polyethylene (PE) or polypropylene (PP); a polycycloolefin resin; a polyimide resin; a polycarbonate resin; a polyurethane resin; triacetate cellulose (TAC); or a mixture thereof. The thickness of the support usually depends on the requirement of the desired optical product, and ranges from 20 to 150 μm. In one embodiment, the support ranges in thickness from 50-75 μm, while in other embodiments the support ranges in thickness from 50-150 μm, 50-100 μm or from 100-150 μm.

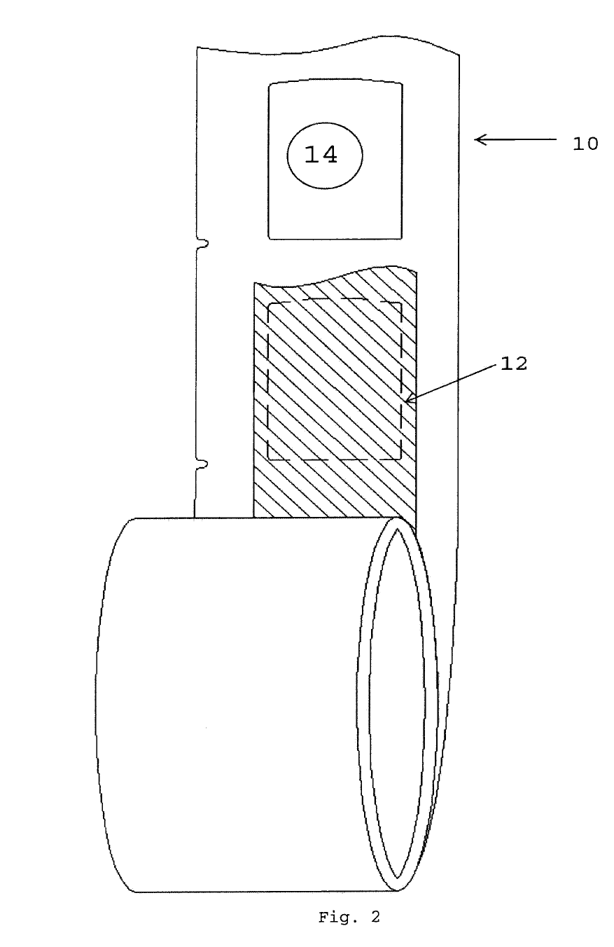

By “releasable liner” we mean any liner known to persons of ordinary skill in the art that will protect the silicone gel but remain removable from the silicone gel. The liner may be applied to the silicone elastomer prior to or during conversion, i.e., die-cutting the optical film into the appropriate sized parts for use (FIG. 2). In use, the liner protects the silicone gel from damage from debris or shock so that the silicone gel maintains its structure and form prior to assembly in an image display device, at which point the liner is removed from the silicone gel. The liner may be any material that provides this protection, including but not limited to polyethylene, polypropylene, polybutene, polybutadiene, polymethylpentene, polyvinyl chloride, vinyl chloride copolymer, polyethylene terephthalate, polybutylene terephthalate, polyurethane, ethylene-vinyl acetate copolymer, polyethylene terephthalate, polyester film, a porous material such as paper, cloth and nonwoven fabric, appropriate thin material such as a net, a foamed sheet, a metal foil, a laminate, or any combination thereof. Specific examples include commercially available materials including but not limited to 3M™ 3M5932, TOPTECH™ Substrate FPET C 50 C(SILFLU 50 MD07) or LOPAREX™ D2.0 CL PET X5015/000. In one embodiment the liner is a plastic film. The thickness of the liner ranges from about 20 to about 150 μm. In one embodiment, the liner ranges in thickness from about 50 to about 75 μm, while in other embodiments the support ranges in thickness from 50-150 μm, 50-100 μm or from 100-150 μm.

The support and liner may be of the same or different materials, depending on the needs of the user. One of skill in the art will be able to determine the preferred material for each, using methods known to the art based on the specific application of the optical film.

By “release tension” we mean the tension required to overcome the adhesion force between the support/liner and the silicone gel. Release tension may be determined by any method known to the art including standard tests such as ASTM D1000, peel tests, pull tests and the like.

In one embodiment, the support release tension from the silicone gel is different from the liner release tension from the silicone gel. The difference in the support release tension from the silicone gel and the liner release tension from the silicone gel is essential to provide the improved workability and durability of the optical film during conversion into die-cut shapes and for automated assembly of the optical film with an image device. If the difference in release tensions between the liner and the support is not accurate (i.e., too high or too low), the converted optical film (i.e., the die-cut optical film with the liner and/or support removed for assembly with an image device) may be deformed or may inadvertently loosen during assembly. The differing release tensions of the support/liner from the optical film of the present invention yield an optical film that is unique over the prior art because the different release tensions of the support and liner balance supporting/protecting the silicone gel with releasability from the silicone gel.

For instance, using a support with a first release tension from the silicone elastomer, defined to mean the tension required to remove the releasable support from the support surface of the silicone gel, means that the support material release tension is high enough to provide adequate support to the silicone gel, yet remains low enough to allow the support to be easily removed from the silicone gel without damaging the gel. Similarly, using a liner with a second release tension, defined to mean the tension required to remove the releasable liner from the liner surface of the silicone gel, means that the liner's release tension is high enough to remain secured to the liner surface during conversion, yet remains low enough to allow the releasable liner to be easily removed from the silicone gel without damaging the gel during assembly with an image display device. In one embodiment, the support release tension ranges from about 0.25-1.90 N/in, and the liner release tension is at least 20% less than the support release tension. In an alternate embodiment the liner release tension is at least 20%-95% less, at least 30%-80% less, or at least 40%-70% less than the support release tension.

The improved release tensions of the optical film of the present invention allow the support and liner to be easily removable from the silicone gel during conversion into a desired shape and during an automated assembly process with an image display device. Using support and liner materials with differing release tensions provides an optical film with an improved durability, workability and re-workability to image display devices during assembly without rupturing the optical film and without leaving any film residue on the display device. This represents an enormous advantage over the prior art. This allows the liner to be more easily removed from the silicone gel than the support is removed from the silicone gel. This means that the liner may be removed without also removing the silicone gel from the support. The difference in release tensions between the support and the liner is essential to a quality optical film for conversion and for automated assembly in an image device. If the release tension of the liner is too high, the optical film may be deformed or loosen from the support when the liner is removed during assembly in an image device.

In one embodiment of the invention, as shown in FIG. 2, the release liner 12, hatchmarks, is added to the optical film 10 of the present invention during die-cutting for assembly with an image display device (not shown). The optical film 10 with the release liner 12 added is cut to the appropriate size and shape 14 for assembly with an image display device (not shown. In an alternate embodiment, the release liner 12 may be added to the silicone gel prior to die-cutting the film 10. The release liner may be removed from the converted optical film (i.e., the optical film die-cut for assembly with an image display device) during assembly. In this way, the support surface of the silicone gel may be protected even after the liner surface of the silicone gel has been modified for assembly in an image device.

The release tensions of the support and liner materials may be modified by methods known to those of skill in the art to accommodate different materials, depending on the needs of the user. One of skill in the art will understand from the present disclosure what degree of difference in release tension would be required, if any, and how to modify the optical film (comprising the silicone elastomer, support and liner) to achieve a specific release tension. For instance, the support and/or liner surfaces of the silicone gel may be modified through treatment with a release agent such as a silicone, fluorine, long-chain alkyl, or fatty acid amide release agent to increase or decrease the release tension with a specific support or liner material. Alternatively, the support and/or liner surfaces of the silicone gel may be subjected to release and antifouling treatment with silica powder or to antistatic treatment of coating type, kneading and mixing type, vapor-deposition type, or the like to increase or decrease the release tension with a specific support or liner material. In particular, if the surfaces of the silicone gel are appropriately subjected to release treatment such as silicone treatment, long-chain alkyl treatment, and fluorine treatment, the release tensions of the support and/or liner materials from the silicone gel can be further modified.

The optical film of the present invention may be manufactured, in one embodiment, using methods similar to methods of manufacturing pressure sensitive adhesives. In step one, the support is applied to the support surface of the silicone gel and pressed in place to secure the releasable attachment between the support and the silicone gel. In step two, the liner is applied to the liner surface of the silicone gel and pressed in place until the releasable attachment is secure. However, in alternate embodiments, different methods of manufacture known to one of skill in the art may also be used.

In alternate embodiments, the optical film may include additional liners and/or functional liners bonded to the support, liner and/or silicone gel (not shown). It is possible to form the optical film of the present invention having additional components in the same way as described above, albeit attaching the additional components to the desired layer of the optical film. These assembly techniques are well known to the art, and will be understood by one of skill in the art given the present disclosure.

By “functional liners” we mean additional functional films and/or additives known to the art for use in optical films. Examples include anti-reflection layers, sticking-prevention layers, diffusion layers, anti-glare layers, UV-shielding layers, photoinitiators, crosslinking agents, inorganic particulates, leveling agents, antifoaming agents, thickeners, neutralizing agent, antistatic agents or combinations thereof. Suitable species of the functional liners are well known to persons having ordinary skill in the art. The thickness of the functional liner ranges from about 20 to 150 μm. In one embodiment, the functional liner ranges in thickness from 50-75 μm, while in other embodiments the functional liner ranges in thickness from 50-150 μm, 50-100 μm or from 100-150 μm.

The present invention further provides an image display device including the optical film of the present invention (not shown). By “image display” we mean, for example, liquid crystal display (LCD) devices, organic electroluminescence devices (OELDs), plasma display panel (PDP) devices, and other well-known devices commonly used in many flat-panel electronic devices, such as portable media players, cellular phones, computer monitors and televisions.

An image display device comprising the optical film of the present invention may be assembled with a novel automated process and machine as disclosed in copending application docket no. 180825.00102, titled “IMAGE DISPLAY ASSEMBLY AND APPARATUS AND METHOD FOR MANUFACTURING THE SAME”, which is hereby incorporated by reference herein for all purposes. The novel release tensions and other properties of the optical film of the present invention are uniquely suited for automated assembly with an image display device that is not provided by the optical films of the prior art.

The following examples are, of course, offered for illustrative purposes only, and are not intended to limit the scope of the present invention in any way. Indeed, various modifications of the invention in addition to those shown and described herein will become apparent to those skilled in the art from the foregoing description and the following examples and fall within the scope of the appended claims.

### EXAMPLES

### Example 1

### Methods and Materials

In this example, the inventors describe how one would prepare the optical film of the present invention.

Supports and liners are provided by commercial suppliers for use in optical films, as known to one of skill in the art. A representative material is clear polyester film such as, for example, 3M™ 5993 Secondary Liner.

The silicone gel is provided by commercial suppliers known to one of skill in the art, and ranges in thickness from 0.05 mm to 2.0 mm. The first release tension (between the support surface of the silicone gel and the support) is 0.635 N/cm. The second release tension (between the liner surface of the silicone gel and the liner) is 0.203 N/cm (JIS Z0237).

The silicone gel of the present invention has a refractive index of greater than 1.4 (at 25° C., 589 nm) as measured according to methods JIS K7412 and ASTM D542. The transmittance at 0.5 mm is greater than 85% (380 nm/JIS K7105, 780 nm/JIS K2207). The Shore Needle hardness is 50-80 (JIS K2207).

The support is contacted with the silicone gel and pressure is applied until the releasable bond is secure. The liner is contacted with the liner surface of the silicone gel and pressure is applied until the releasable bond is secure. Additional liners and/or functional liners may be added in the same manner.

### Example 2

### Reworkability

In this example, the inventors describe how one would evaluate the reworkability of the optical film of the present invention.

Samples of the optical film, cut into 42 mm long×32 mm wide pieces, are attached with a laminator to both sides of a 0.7 mm-thick glass plate (1737, Corning Incorporated) under high vacuum condition, forming a sandwich structure of glass-film-glass. For rework process, a metal jig is used to create a small gap between the film and glass from the edge, then several drops of low polarity organic solvent (e.g. Isopropyl alcohol) is injected into the gap, the solvent immerses along the interface between film and glass to release the adhesion. The glass is separated finally from the whole structure. After that, the optical film can be peeled off by hand from another glass or LCD, and reworkability was evaluated according to the criteria described below.

In general, the reworkability of each sample is evaluated according to three broad categories. Sample pieces that are successfully peeled off from all substrates with no residue, no film rupture and no glass rupture/scratched are considered exhibits of good reworkability. Sample pieces that exhibited film rupture or glass rupture (not LCD), but LCD were successfully peeled off by re-peeling are considered exhibits of fair reworkability. LCDs that ruptured or scratched during testing were considered as failing.

### Example 3

### Durability

In this example, the inventors describe how one would evaluate the durability of the optical film of the present invention.

Samples of the optical film, cut into 420 mm×240 mm pieces, are attached with a laminator to both sides of a 0.7 mm-thick non-alkali glass plate (1737 manufactured by Corning Incorporated) in the crossed Nicol arrangement. The sample laminate is autoclaved at 50° C. and 0.5 Mpa for 15 minutes so that the sample pieces are completely adhered to the non-alkali glass plate. After this process, the sample is stored for 500 hours at 80° C., 90° C., 95° C., 100° C., or 60° C./90% RH, and then foaming, peeling or separation is visually evaluated.

Samples that exhibit neither foaming, peeling nor separation are considered to exhibit good durability. Samples that exhibit foaming, peeling or separation are further evaluated to determine if the foaming, peeling or separation is only visually unacceptable, but remains at a functionally acceptable level. Samples that exhibit practically unacceptable foaming, peeling or separation are not considered to exhibit good durability.

### Example 4

### Measuring Release Tension

In this example, the inventors demonstrate how one would measure the release tension of a given material.

Following the procedure for ASTM D1000, the standard test method for Pressure Sensitive Adhesive-Coated Tape for Electrical and Electronics Use, the following materials are used. AR-1000 Adhesion/Release Tester or Instron Mini44 Tensile Tester, Solvent: IPA, MEK, Acetone; Test panel, Clean cloth, and 5 strips of (approx. 1″ width×6″ length), 4.5 lbs (2 kg) rubber roller.

In use, 5 samples of the optical film are prepared by measuring 1″ width by 6″ length of the film using a 1″ size cutter. For consistency, the samples are aligned with a ruler. Otherwise, strips can be cut using a penknife and a 1″ width metal ruler. An additional 5 strips of a liner material, measuring approximately 2″ width by 5″ length size, are prepared using a penknife and metal ruler. A clean cloth is dipped with solvent, and each of the samples is thoroughly cleaned with the solvent. The samples are cleaned again using a new clean wet cloth for 5 times in one lengthwise direction. The samples are then pasted on to the liner to be tested The sample should be centrally aligned along the length of liner/test panel assembly. The sample should then be conditioned and dwelled for 20 minutes or 24 hours at room temperature. Dwelling time and conditioning may vary according to application requirement.

After the dwelling time, the release liner test is performed by machine (AR-1000 or Instron Tensile Test) at a speed of 300 mm/min (12″/min). Speed may vary according to application requirement. For a high-speed release test, AR-1000 is recommended.

While there has been shown and described what is at present considered the preferred embodiment of the invention, it will be obvious to those skilled in the art that various changes and modifications can be made therein without departing from the scope of the invention defined by the appended claims.

We claim:

1. An optical film comprising
a. a silicone elastomer having a support surface and an opposing liner surface;
b. a releasable support contacting at least a portion of the support surface; and
c. a releasable liner contacting at least a portion of the liner surface,
wherein the releasable support has a first release tension from the silicone elastomer and the releasable liner has a second release tension from the silicone elastomer, thereby providing an optical film.

2. The optical film of claim 1 wherein the first release tension and the second release tension are different.

3. The optical film of claim 2 wherein the first release tension is higher than the second release tension.

4. The optical film of claim 3 wherein the first release tension ranges from 0.25-1.90 N/in, and the second release tension is at least 20% less than the first release tension.

5. The optical film of claim 1 wherein the releasable liner has a release tension ranging from at least 40-70% less than the support release tension.

6. The optical film of claim 1 wherein the releasable support is selected from the group consisting of metal, ceramic, glass, polyester resin, a polyacrylate resin, a polyolefin resin, a polycycloolefin resin, a polyimide resin, a polycarbonate resin, a polyurethane resin, triacetate cellulose (TAC) or mixtures thereof.

7. The optical film of claim 1 wherein the releasable support ranges in thickness from 20-150 μm.

8. The optical film of claim 7 wherein the releasable support ranges in thickness from 50-100 μm.

9. The optical film of claim 1 wherein the releasable liner ranges in thickness from 20-150 μm.

10. The optical film of claim 9 wherein the releasable liner ranges in thickness from 50-100 μm.

11. The optical film of claim 1 wherein the releasable liner is selected from the group consisting of polyethylene, polypropylene, polyethylene terephthalate, polyester, polybutene, polybutadiene, polymethylpentene, polyvinyl chloride, vinyl chloride copolymer, polyethylene terephthalate, polybutylene terephthalate, polyurethane, ethylene-vinyl acetate copolymer, paper, cloth, nonwoven fabric, a net, a foamed sheet, a metal foil, a laminate and combinations thereof.

12. The optical film of claim 1 wherein the silicone elastomer has a refractive index greater than 1.4.

13. The optical film of claim 1 wherein the silicone elastomer ranges in thickness from 0.05 mm-2 mm.

14. The optical film of claim 1 wherein the silicone elastomer ranges in thickness from 0.15-1 mm.

15. An image display device comprising the optical film of claim 1, wherein the releasable support and releasable liner have been removed from the optical film.

16. An optical film comprising
a. a silicone elastomer having a support surface and an opposing liner surface;
b. a releasable support contacting at least a portion of the support surface; and
c. a releasable liner contacting at least a portion of the liner surface,
wherein the releasable support has a first release tension ranging from about 0.25-1.90 N/in from the silicone elastomer and the releasable liner has a second release tension at least 20% less than the first release tension from the silicone elastomer, thereby providing an optical film.

17. The optical film of claim 16 wherein the releasable support comprises a different material from the releasable liner.

18. The optical film of claim 16 wherein the releasable support is selected from the group consisting of metal, ceramic, glass, polyester resin, a polyacrylate resin, a polyolefin resin, a polycycloolefin resin, a polyimide resin, a polycarbonate resin, a polyurethane resin, triacetate cellulose (TAC), or mixtures thereof.

19. The optical film of claim 16 wherein the releasable liner has a release tension ranging from at least 40-70% less than the support release tension.

20. An image display device comprising the optical film of claim 16, wherein the releasable support and releasable liner have been removed from the optical film.
